(19) United States
(12) Patent Application Publication
(10) Pub. No.: US 2008/0168536 A1
(43) Pub. Date: Jul. 10, 2008

(54) SYSTEM AND METHODS FOR REDUCTION OF UNWANTED ELECTRONIC CORRESPONDENCE

(76) Inventor: Mark C. Rueckwald, Rochester, NY (US)

Correspondence Address: Stephen B. Salai, Esq.;Harter, Secrest & Emery LLP, 1600 Bausch & Lomb Place, Rochester, NY, 14604-2711, US

(21) Appl. No.: 11/621,700

(22) Filed: Jan. 10, 2007

(51) Int. Cl. G06F 7/04

(52) U.S. Cl. 726/4

(57) ABSTRACT

A system for authenticating electronic correspondence includes a sender, a recipient, and a central authorization service. The sender includes a correspondence client at which electronic correspondence is composed, a correspondence server for routing proposed correspondence, and a sender client. The recipient includes a correspondence client at which electronic correspondence is viewed, a correspondence server that delivers the correspondence to the correspondence client, and a recipient client. The central authorization service has a two-way communication link to each of the sender client and the recipient client. The sender client is configured to determine whether composed correspondence to be sent originates from at least one of an authorized server and an authorized domain before sending the correspondence and informs the central authorization service if a determination is made if the correspondence does not originate from an authorized server or an authorized domain. The recipient client determines the authenticity of received correspondence and only upon a determination of authenticity forwards the message to the correspondence server for routing to the recipient client.

### BACKGROUND OF THE INVENTION

1. Field of the Invention

The present invention relates generally to the field of electronic correspondence. More specifically, the present invention relates to a system for controlling the transmission and reception of electronic correspondence to substantially reduce the amount of unwanted correspondence.

2. Brief Description of the Related Art

Electronic mail has become a primary means of communication for a large number of organizations, businesses, and individuals. Electronic mail is particularly popular for its simplicity, efficiency, and its virtual non-existant cost.

However, the very advantages of e-mail and similar electronic correspondence have also caused a problem for users of such correspondence. Specifically, users of e-mail and other electronic correspondence are being abused by what are commonly referred to as “spammers.” Such spammers send a large amount of unsolicited and illegitimate e-mail at virtually no cost to the sender. However, the recipient of such messages has increased costs associated with the necessary memory required to save unsolicited e-mails, the time required by users to filter through the unwanted e-mails, and the general annoyance associated with spam.

To date, numerous methods have been proposed and implemented to attempt to filter unsolicited correspondence from legitimate correspondence. Specifically, anti-spam filters including software and firewalls are well known in the art. However, all previous systems place the emphasis and costs on the recipient, while little, if any, burden or liability is placed on the sender. Other known methods attempt to implement a form of encryption or utilize a stamp of authenticity to protect or identify electronic correspondence. However, such solutions are becoming more and more complex and expensive to implement as spammers become more resourceful and knowledgeable about their craft. Moreover, as recipients are required to do additional filtering and place additional restrictions on their e-mail servers, and the like, the amount of legitimate correspondence being lost has increased.

Accordingly, there is a need in the art for an improved method and system for certifying electronic correspondence between legitimate senders and recipients. There is also a need in the art for a system of filtering electronic correspondence that benefits and burdens the sender and recipient equally. Moreover, there is a need in the art for a system of filtering electronic correspondence that enables recognizing and blocking spammers using the system, to avoid transmission of spam.

### BRIEF SUMMARY OF THE INVENTION

The present invention remedies the foregoing problems in the art by providing a system for authenticating electronic correspondence. The system includes a sender, a recipient, and a central authorization service. The sender includes a correspondence client at which electronic correspondence is composed, a correspondence server for routing composed correspondence to the recipient client checks message then forwards to e-mail server, and a sender client. The recipient includes a correspondence client at which electronic correspondence is viewed, a correspondence server that delivers the correspondence to the correspondence client, and a recipient client. The central authorization service has a two way communication link to each of the sender client and the recipient client. The sender client is configured to determine whether composed correspondence to be sent originates from at least one of an authorized server and an authorized domain before sending the correspondence and informs the central authorization service if a determination is made that the correspondence does not originate from an authorized server or an authorized domain. The recipient client determines the authenticity of received correspondence and only upon a determination of authenticity forwards to the message to the recipient correspondence server for routing to the recipient client.

The present invention also provides a method of authenticating electronic correspondence between a sender and a recipient. The method includes a step of providing a sender client at the sender and a recipient client at the recipient, registering the sender client and recipient client with a central authorization service, establishing a two-way communication link between the sender client and the central authorization service and a two-way communication link between the recipient client and the central authorization service, at the sender, creating an electronic correspondence for transmission to the recipient, authorizing in the sender client transmission of the electronic correspondence, at the recipient client verifying the authenticity of the electronic correspondence, and upon verification forwarding the correspondence to the recipient correspondence server allowing the recipient to view the electronic correspondence.

The present invention also provides a method of authenticating electronic correspondence from a sender having a sender client, the sender client being in two-way communication with a central authorization service. The method includes receiving composed electronic correspondence in the sender client, determining whether the electronic correspondence is received from a service registered with the central authorization service, determining whether the electronic correspondence is received from a domain registered with the server on the central authorization server when the correspondence is determined to be from a registered server, and, when it is determined that the server and domain are registered, encrypting and sending the electronic correspondence. In a still further embodiment, the present invention provides a method of authenticating electronic correspondence by a recipient having a recipient client, the recipient client being in two-way communication with the central authorization service. The method includes receiving sent electronic correspondence by the recipient client, validating an originating address of the electronic correspondence, and forwarding the electronic correspondence to the recipient upon validation of the originating address of the electronic correspondence. The originating address of the electronic correspondence is validated by determining at least one of whether the originating address of the electronic correspondence is from a sender registered on the recipient client, whether the originating address is a predetermined trusted address, and whether the originating address is authorized by the central authorization service.

These and other aspects and features of the present invention may be better understood by reference to the accompanying drawings and written description, in which preferred embodiments of the present invention are shown and described.

### BRIEF DESCRIPTION OF THE SEVERAL VIEWS OF THE DRAWING(S)

FIG. 1 is a schematic diagram showing a conventional system for sending and receiving electronic correspondence.

FIG. 2 is a schematic diagram showing a system for sending and receiving electronic correspondence according to a first embodiment of the present invention.

FIG. 3 is a flow chart showing a procedure for setting up a system according to FIG. 2.

FIG. 4 is a flow chart showing a process by which electronic correspondence is sent in a preferred embodiment of the present invention.

FIG. 5 is a flow chart showing a process by which an electronic correspondence is received by a recipient according to the present invention.

FIG. 6 is a flow chart showing a process by which suspected spam is handled according to a preferred embodiment of the present invention.

### DETAILED DESCRIPTION OF THE PREFERRED EMBODIMENTS

The present invention will be described with reference to the figures.

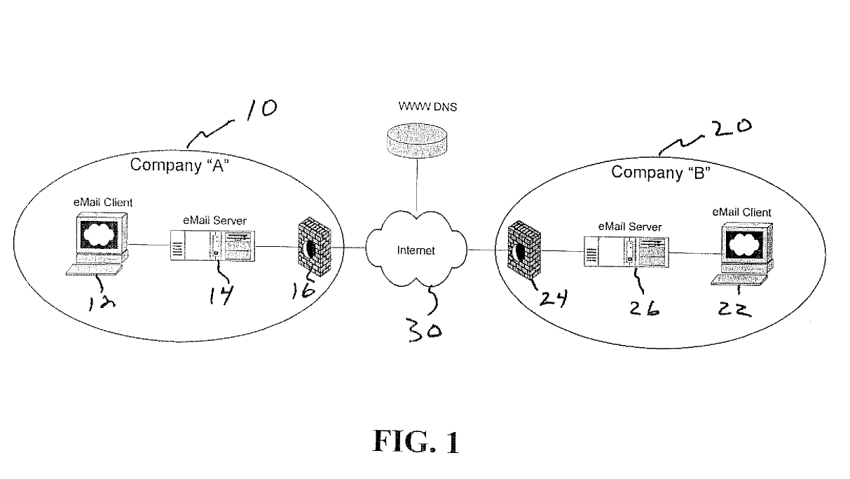

FIG. 1 illustrates a conventional configuration for implementing electronic correspondence between two entities. As illustrated therein, a plurality of entities 10, 20 (two are illustrated in FIG. 1) are connected by the Internet 30. Correspondence is sent by a sender 12 over the Internet 30 for receipt by a recipient 22. Upon receipt, the correspondence is first routed through a firewall 24, then is received in an e-mail or electronic correspondence server 26, which further routes the correspondence to an e-mail client 22 or user interface for viewing by the user. Conversely, when e-mail is to be sent from the e-mail client 22, an IP address is obtained and the message is sent out through the firewall 24 to the respective companies e-mail server 14 which is then available for ultimate delivery when the recipient connects via their e-mail client. Prior to reception of the e-mail, the e-mail server preferably performs a DNS lookup to determine a valid e-mail server it trusts for the respective domain that is being used, and performs any filtering.

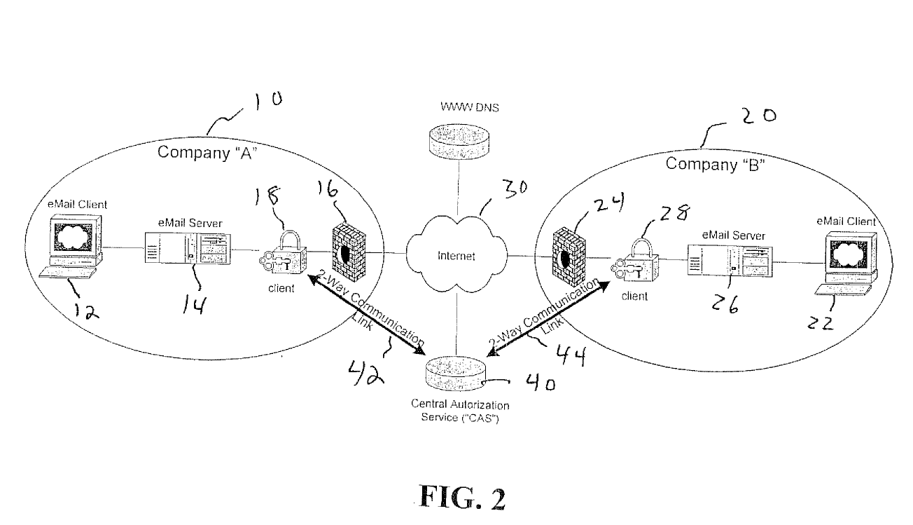

FIG. 2 shows the preferred configuration of a system according to the preferred embodiment. As illustrated, each entity 10, 20, or customer, employs a firewall 16, 24, an e-mail server 14, 26, and an e-mail client 12, 22, substantially the same as those provided in the conventional system. However, a “client” 18, 28 in accordance with this invention is also is provided between the e-mail server and the Internet at each customer. Moreover, a central authorization service (CAS) 40 is located on the Internet and is accessible to each of the clients.

Preferably, a bi-directional communication 42, 44 is established between the client and the CAS. Accordingly, if communication is ever lost from the CAS to the client, the CAS may be able to perform e-mail verifications and server/domain named certificate replications As shown in FIG. 31 the client preferably is installed on a dedicated server, a network appliance, or the firewall, and the client preferably creates and encrypts both a “Configuration Log” and an “e-mail Log.” The configuration log preferably is used to install an audit trail of any configuration changes. The e-mail Log preferably stores any e-mail that is processed by the client to be used later when the client is audited by the CAS, as will be described in more detail below.

Once the customer has established a link with the CAS, an account is created within the CAS. More specifically, each customer must register its domain names with the CAS. Any combination of manual or automated techniques may be utilized to ensure that the account holder is both a legitimate entity and has a legal claim to the domain names being requested. In this manner, illegitimate entities, including spammers, are potentially denied access to the system.

With an account successfully created, the customer's client is joined to the CAS using login credentials used to initially validate the connection utilizing an SSL connection from the CAS. Using a secure channel, the client provides to the CAS its routable IP address and hard drive serial number or other hardware specific number, which is used as the clients' ID. This client ID is registered, and the CAS provides two keys to the client. The keys are a password key, for use in conjunction with the client ID, and an SSL encryption key, for supporting the CAS to securely log into the client. As with any other configuration changes, the details of this update are entered into the configuration log.

Having established the relationship between the CAS and the client, the client downloads and installs the domain name and digital certificates for the customer's domains. Once the available domain names are authorized in the client, the customer's network administrators or the like configure their hardware by designating which correspondence servers and/or e-mail clients are authorized to send e-mail messages and then which domains are authorized to send messages from which servers. In a first step, each correspondence server network connection must be specified to send messages which will be based on a combination of the e-mail servers network interfaces' IP address, and M.A.C. addresses, and port numbers. With the server specified and logged, the available domain names may be allocated to the desired servers and server network interfaces. Once all configurations have been complete, the client connects to the CAS and updates its records for any changes which were made to its configuration. In this manners the CAS and customer are configured for use in the preferred system of the invention.

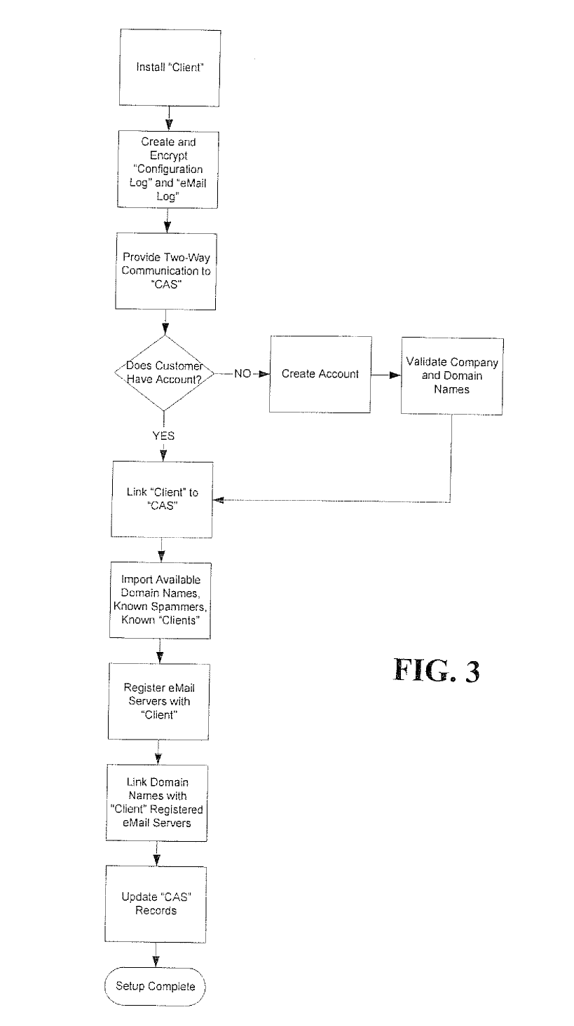

The process just described for initiating installation of a client and establishing communication between the client and the CAS is set forth diagrammatically in FIG. 3. Specifically, FIG. 3 shows a flow chart for establishing a secure bidirectional communication between a client and the CAS.

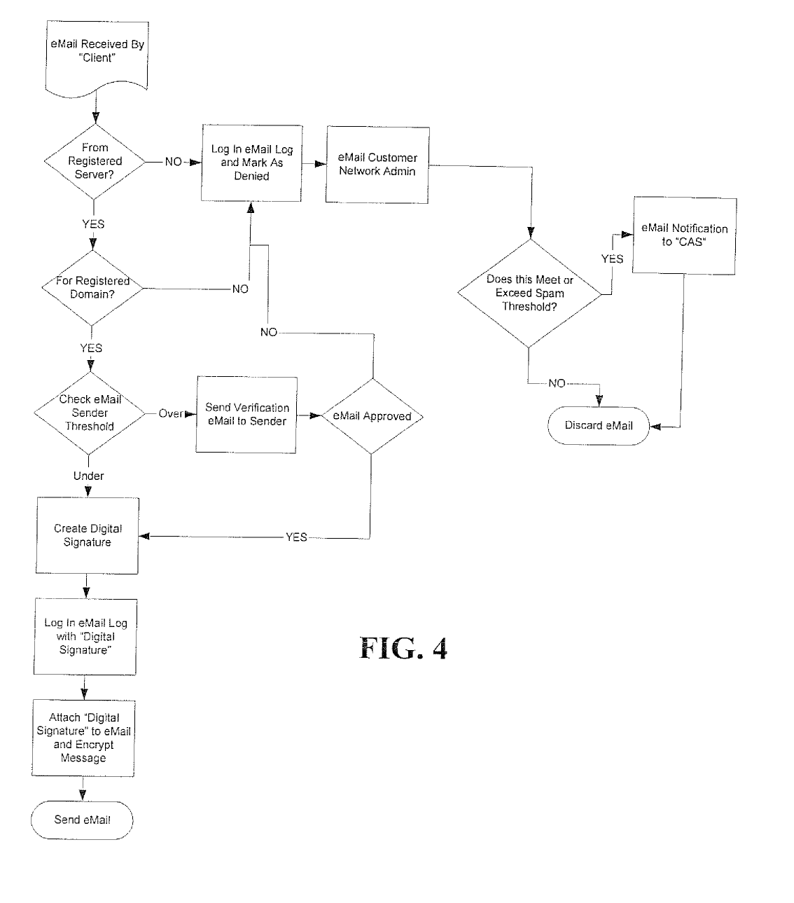

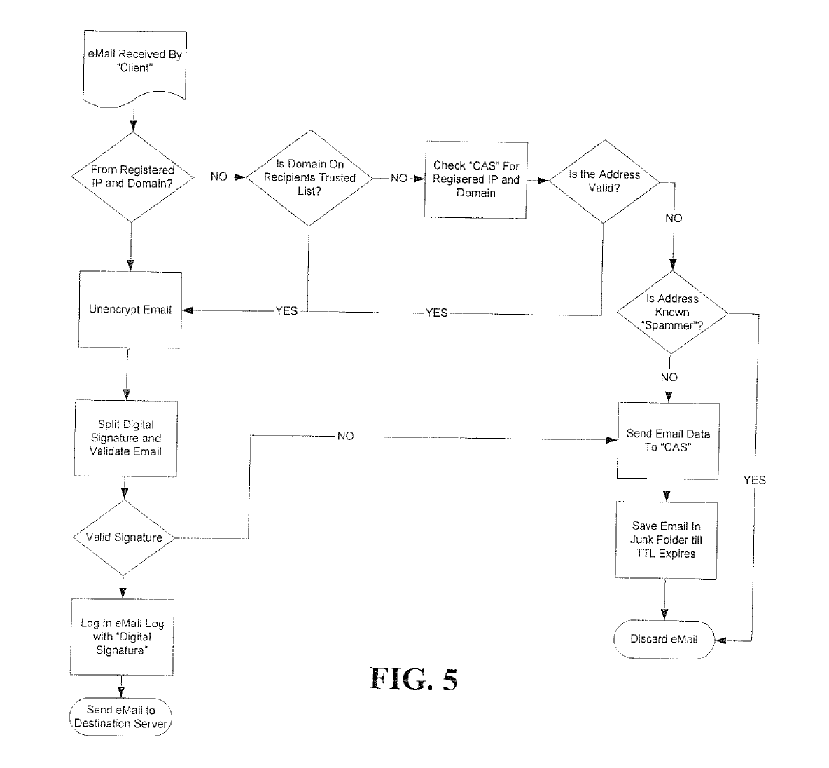

Having thusly configured the preferred system of a preferred embodiment of the invention, FIGS. 4 and 5 will be used to describe processes for sending and receiving electronic correspondence, respectively.

The processing of outbound electronic correspondence will be described first with reference to FIG. 4. Electronic correspondence is drafted at a user interface or e-mail client by a user. When “sent” by the user, the e-mail correspondence server forwards the message to the installed client for processing. Specifically, the client first determines whether the e-mail to be sent to an external entity is from a registered server. If the e-mail is determined not to be from a registered server, the message is logged into the e-mail Log and is marked as denied. When it is determined that the e-mail received in the client is from a registered server, the client then ascertains whether the correspondence is for a domain registered to that server. If the correspondence is not from a registered domain, the correspondence is logged into the e-mail Log and marked as denied.

When the client receives an e-mail from a valid server and associated domain, a digital signature is created of the electronic correspondence and is stored in the e-mail Log as a sent message along with other relevant information. Such information may include one or more of a time stamp (date and time message sent, recipient's IP address, e-mail address and sender's e-mail) subject line and similar items. The digital certificate is attached to the e-mail, the entire e-mail message is encrypted using the clients' private key, and the message is sent.

Even after the client has determined that an e-mail has been received from a valid server and associated domain, it is possible that such an e-mail may be the result of corruption of the sender's correspondence server or client computer and therefore be spam. In order to inhibit the transmission of messages from a corrupted correspondence server or client computer, if a client receives a number of messages from a correspondence server that exceeds a predetermined threshold or receives a message addressed to more than a predetermined number of recipients, the message may be marked as potential spam and the client sends notification, for example, an e-mail message to the originator of the suspect electronic correspondence and inhibits transmission of the correspondence over the network.

When the client determines that the electronic correspondence is from either an unregistered server, or for an unregistered domain name for a registered server, a digital signature of the correspondence is created, and the correspondence and digital signature are stored in the e-mail Log as a denied message. An e-mail message (i.e., an internal e-mail message) is then sent to the customers' network administrator to inform of the violation. After the internal e-mail has been sent, the client checks the e-mail Log to determine whether the denied e-mail raises a number of denied e-mails above a predetermined threshold set by the CAS for a particular client. If the threshold is reached or exceeded, the CAS is informed of the violation, and the CAS can use this and other information to see if the customer's network has been either compromised or is a spamming organization. Appropriate actions may then be taken. For example, the user's rights may be suspended or the client certificates revoked. The e-mail sent back to the network administrator who may then determine whether the e-mail should be sent or discarded. Moreover, the network administrator may determine that configurations may be in need of updating.

The process by which e-mails are received by a customer in the preferred embodiment of the invention now will be described with reference to FIG. 5.

E-mail sent to a customer is received by the customer's client regardless of the sender of the electronic correspondence (i.e., regardless of whether the sender is also a registered customer). Once received by the client, the originating address and domain are checked within the client's local database of known client/domain pairs. If no corresponding entry is found, the client determines whether the domain name is instead on a trusted domain list of the customer. If the correspondence fails both of these checks, the client connects to the CAS to determine whether the domain is in fact authorized, but was recently added and thus has not yet made it to the client's database of trusted sites. If any of these checks pass, the correspondence moves on to be processed.

Conversely, if it is determined that the originating address and domain of the correspondence is not from a known client/domain pair, is not a trusted domain list, and is not registered with CAS as a trusted source, the client will endeavor to determine whether the correspondence is spam. Specifically, the originating IP address is checked to determine whether the CAS database already associates the origin address with a spammer. If the originating IP address is associated with a spammer, a log of the e-mail is retained and the message is discarded. If no corresponding spammer association is found, however, the digital signature and specifics are sent to the CAS to be included in future spammer identification. Accordingly, any further correspondence from the same source may be considered spam. Finally, the correspondence is saved on the client's server for a period of time set by the customer. For this period of time, the customers' network administrator may view the saved messages and may either accept or discard them as they see fit. Moreover, the administrator may determine that configuration changes need be made, for example, if it is determined that correspondence from a known and trusted address is not being delivered. Preferably, upon expiration of the time limits set by the customer, the messages are discarded to prevent accumulation of an excess of messages.

When the client determines that the message is either from a known client/domain pair, is on a trusted domain list, or is registered with the CAS, the client proceeds to decrypt the message using the public key provided to it. Once the message is decrypted, the digital signature created by the originating client is removed from the e-mail, so that the e-mail is in its original sending state and then another check sum is created against the e-mail which is compared to the check sum in the signature.

in the preferred embodiment, however, the client performs a procedure on the e-mail that includes generating a numeric check sum and compares the results of this process with the digital signature included with the correspondence. This step is a further verification to ensure that the correspondence was not compromised. If, however, this check shows that the message was compromised, the particulars of the e-mail are sent to the CAS as a red flag representing that the e-mail is compromised by a potential hacker or spammer. If the comparison shows that the e-mail was originally as sent, and is from a trusted source, an e-mail log entry is created and the message is forwarded to the destination server for viewing by the intended recipient.

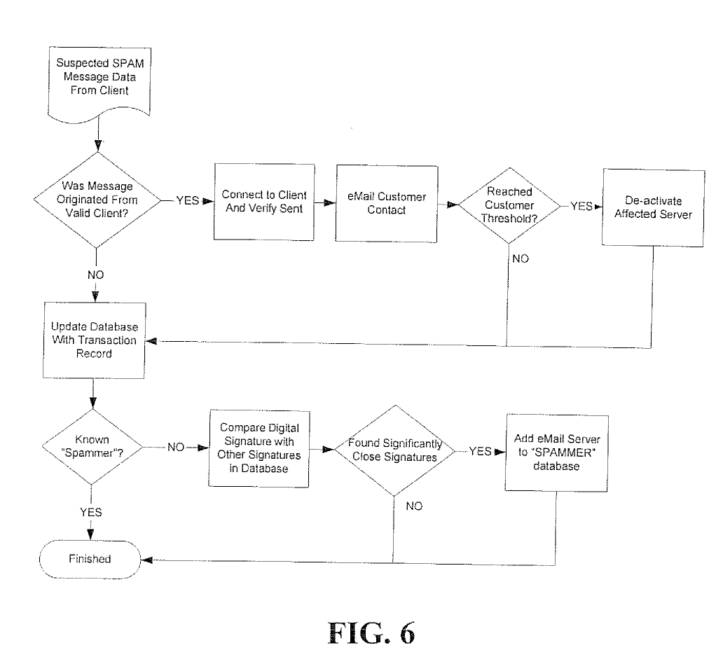

The method used by the CAS to determine whether a sender of an e-mail is a spammer is illustrated in FIG. 6. As illustrated therein, suspect correspondence is received in the CAS from the recipient's client. The CAS makes a determination at this point whether the message originated from a valid client (i.e., determines whether the sender of the message was a valid client). If the source of the correspondence was a valid client, the CAS connects to the originating client and preferably autonomously checks the client's e-mail log to verify that the message did, in fact, originate from that client. With this information, the CAS may automatically generate a message to inform the originating customer that a potential spam message was sent and it was or was not found in the customer's client. The CAS preferably also checks to determine whether the correspondence causes a predetermined threshold of “junk” correspondence to be exceeded. If the threshold is exceeded, the CAS connects to the client and takes appropriate measures. For example, the CAS may suspend the certificate for the server/domain name in question. The CAS database is updated with the information available relating to the attempted correspondence.

The CAS also determines if potential spam correspondence originated from a known spammer. If the CAS determines that the mail is from a known spammer, no further action is taken, inasmuch as the spammer is already registered on the CAS database as being a spammer. However, if the originator of the correspondence is not a known spammer, the digital signature of the correspondence is compared to those digital signatures in the CAS database. In this manner, it is determined whether the correspondence is significantly close in content to other correspondence saved on the CAS database. Once a sufficient number of significantly similar correspondences are found, the originating address is associated with a known spammer on the CAS database.

The foregoing embodiments of the invention are representative embodiments, and are provided for illustrative purposes only. The embodiments are not intended to limit the scope of the invention. Variations and modifications are apparent from a reading of the preceding description and are included within the scope of the invention. The invention is intended to be limited only by the scope of the accompanying claims.

1. A system for authenticating electronic correspondence, the system comprising:
a sender including a correspondence client at which electronic correspondence is composed, a correspondence server for routing composed correspondence, and a sender client;
a recipient including a correspondence client at which electronic correspondence is viewed, a correspondence server that delivers the correspondence to the correspondence client, and a recipient client; and
a central authorization service having a two-way communication link to each of the sender client and the recipient client,
wherein the sender client is configured to determine whether composed correspondence to be sent originates from at least one of an authorized server and an authorized domain before sending the correspondence and informs the central authorization service if a determination is made that the correspondence does not originate from an authorized server or an authorized domain, and
wherein the recipient client determines the authenticity of received correspondence and only upon a determination of authenticity forwards the message to the correspondence server for routing to the recipient client.

2. The system according to claim 1, wherein the central authorization server revokes privileges of the sender client when the determination is made that the correspondence does not originate from an authorized server or an authorized domain.

3. The system according to claim 1, wherein the electronic correspondence is encrypted prior to sending.

4. The system according to claim 1, wherein each of the sender client and the recipient client has at least one key for at least one of encrypting and decrypting electronic correspondence

5. The system according to claim 1, wherein a log is maintained of all electronic correspondence sent by the sender and received by the recipient.

6. The system according to claim 1, wherein information relating to the received correspondence is forwarded to the central authorization server when the recipient client determines that the received correspondence is not authentic and the central authorization server maintains the received correspondence in a database to catalog spammers.

7. A method of authenticating electronic correspondence between a sender and a recipient, the method comprising the steps of:
providing a sender client at the sender and a recipient client at the recipient;
registering the sender client and the receiver client with a central authorization server;
establishing a two-way communication link between the sender client and a central authorization server and a two-way communication link between the receiver client and the central authorization server;
at the sender, creating an electronic correspondence for transmission to the recipient;
authorizing, in the sender client, transmission of the electronic correspondence;
at the recipient client, verifying the authenticity of the electronic correspondence; and
allowing the recipient to view the electronic correspondence upon verification.

8. The method according to claim 7, wherein the sender client authorizes transmission of the electronic correspondence after verifying that a source of the creation of the electronic correspondence is at least one of a valid server and a valid domain.

9. The method according to claim 8, wherein the receiver client verifies the authenticity of the electronic correspondence by confirming at least one of (a) that the sender has a sender client, (b) that the sender is a trusted domain registered on the recipient client, and (c) that the sender is registered with the central authorization server.

10. A method of authenticating electronic correspondence in a sender having a sender client, the sender client being in two-way communication with a central authorization server, the method comprising:
receiving composed electronic correspondence in the sender client;
determining whether the electronic correspondence is received from a server registered with the central authorization server;
determining whether the electronic correspondence is received from a domain registered with the server on the central authorization server when the correspondence is determined to be from a registered server, and
when it is determined that the server and domain are registered, encrypting and sending the electronic correspondence.

11. The method according to claim 10, further comprising the steps of when it is determined that the electronic correspondence was generated by a non-registered server or a non-registered domain, denying the electronic correspondence and informing the central authorization server.

12. The method according to claim 10, further comprising the steps of, when it is determined that the electronic correspondence was generated by a registered server and a registered domain, determining whether the number of messages sent exceeds a predetermined threshold or whether the number of addressees of the message exceeds a predetermined threshold and based on such determination sending a message back to the originator alerting them that the message may be unauthorized.

13. The method according to claim 11, further comprising the step of generating and forwarding a message to the sender that the electronic correspondence was generated by at least one of a non-registered server and a non-registered domain.

14. The method according to claim 12, further comprising the steps of determining whether a number of electronic correspondences generated by at least one of the non-registered server and the non-registered domain exceeds a predetermined number, and informing the central authorization server if it is determined that the predetermined number is exceeded.

15. The method according to claim 13, further comprising determining one of whether the sender is a spammer and whether the sender has been compromised.

16. A method of authenticating electronic correspondence in a recipient having a recipient client, the recipient client being in two-way communication with a central authorization server, the method comprising:
Receiving sent electronic correspondence in the recipient client;
Validating an originating address of the electronic correspondence by determining at least one of whether the originating address of the electronic correspondence is from a sender registered on the recipient client, whether the originating address is a predetermined trusted address, and whether the originating address is authorized by the central authorization server;
forwarding the electronic correspondence for viewing on the recipient upon validation of the originating address of the electronic correspondence.

17. The method according to claim 16, wherein the electronic correspondence is encrypted and further comprising the step of decrypting the electronic correspondence before forwarding the electronic correspondence for viewing.

18. The method according to claim 17, wherein when the originating address is not validated, the central authorization server is notified.

19. The method according to claim 18, wherein, upon notification of a non-validated originating address, the central authorization server determines the sender is a spammer and stores information relating to the electronic correspondence for future recognition as a spammer.

20. The method according to claim 16, further comprising the steps of, after validating the originating address, checking that the electronic correspondence was created by a registered server on the sender and a domain name associated with the registered server.
